(19) United States
(12) Patent Application Publication
(10) Pub. No.: US 2020/0332860 A1
(43) Pub. Date: Oct. 22, 2020

(54) TRANSMISSION DEVICE

(71) Applicant: VANDERBILT UNIVERSITY, Nashville, TN (US)

(72) Inventor: Harrison L. BARTLETT, Nashville, TN (US)

(21) Appl. No.: 16/763,263

(22) PCT Filed: Nov. 13, 2018
(86) PCT No.: PCT/US2018/060619

§ 371 Date: May 12, 2020

Related U.S. Application Data
(60) Provisional application No. 62/585,160, filed on Nov. 13, 2017.

(51) Int. Cl. F16H 1/32; H02K 41/06

(52) U.S. Cl. CPC F16H 1/321; F16H 49/001; H02K 41/065

(57) ABSTRACT

Various implementations include transmission devices for reducing angular speed using a nutating intermediate plate that does not rotate about the central axis of the transmission relative to the transmission housing. Various implementations of the transmission devices are able to achieve high transmission ratios in a single, compact stage while maintaining high efficiency and leverage simple components that can be easily manufactured using standard machining practices.

### BACKGROUND

Actuators are ubiquitous in modern day life. Most actuators consist of a driving unit and a transmission. In the case of a typical electromechanical actuator, the driving unit is an electric motor, and the transmission may be a variety of transmission components such as gears and/or power screws. Electric motors are commonly used driving units due to their ease of controllability and high power density. Although electric motors are power-dense, their high power is only available at high speeds and low torques relative to most applications. To resolve this speed and torque discrepancy, transmission elements are often used to decrease actuator speed.

In many applications, transmissions require a reduction ratio on the order of 100:1. Such large transmission ratios can be achieved with a variety of transmission components, but most commonly these components are arranged in series, comprising multiple stages in the transmission. Multistage transmissions are able to achieve high ratios, but at the cost of large transmissions with high mass and inertia. Additionally, multistage transmissions can result in a low efficiency drive system due to the friction in each stage of the transmission.

For many applications, a compact and lightweight actuator is desirable. However, the large size of most multistage transmissions can make such desires unattainable. To tackle this problem, transmission systems have been created that can achieve high transmission ratios (on the order of 100:1) in a single stage. However, the currently available high ratio single stage transmissions are inefficient and costly to manufacture. Two known high ratio single stage transmissions include harmonic drives and cycloid drives. These transmissions tend to be costly, difficult, and expensive to manufacture relative to multistage transmissions. Additionally, these transmissions achieve relatively low efficiencies relative to their multistage counterparts.

A promising development in transmission technologies is the work being done in the area of nutation-based transmission systems. These systems are able to achieve high transmission ratios in a compact package by leveraging the kinematics of a nutating disk. These pericyclic transmissions provide high transmission ratios while maintaining relatively high mechanical efficiencies. However, improvements in these transmission technologies are needed in the prior art.

### SUMMARY

Various implementations include speed reduction devices for reducing angular speed using a nutating intermediate plate that does not rotate about the central axis of the transmission relative to the transmission housing.

In one implementation, an example speed reduction device includes a housing having an axis of rotation and a vertical wall. The device also includes a driven plate having an axis of rotation that is coincident with the axis of rotation of the housing. The driven plate has a first side and a second side that are spaced apart and opposite each other along the axis of rotation of the driven plate. The driven plate is disposed within the housing.

The device further includes a drive plate having an axis of rotation that intersects the axis of rotation of the driven plate at a precession angle greater than zero. The drive plate has a first side and a second side that are spaced apart and opposite each other along the axis of rotation of the drive plate. The drive plate is disposed within the housing.

The device further includes an intermediate plate having an axis of rotation that intersects the axis of rotation of the driven plate at the precession angle. The intermediate plate has a first side, a second side, and a perimeter extending between the first side and the second side, the first and second sides being spaced apart along the axis of rotation of the intermediate plate. The intermediate plate is disposed within the housing between the drive plate and the driven plate.

The device further includes at least one angular stop coupling the intermediate plate and the housing. The at least one angular stop prevents the intermediate plate from rotating relative to the housing and allows the axis of rotation of the intermediate plate to precess about the axis of rotation of the driven plate. The rotation of the drive plate about the axis of rotation of the driven plate at an angular speed urges the intermediate plate to nutate about the axis of rotation of the driven plate. The nutation of the intermediate plate in turn causes the driven plate to rotate about the axis of rotation of the driven plate at an angular speed that is less than the angular speed of the drive plate.

In some implementations, the driven plate comprises a driven positive engagement device on the first side of the driven plate, and the intermediate plate comprises an intermediate positive engagement device on the second side of the intermediate plate. The intermediate positive engagement device is engagable with the driven positive engagement device.

In some implementations, the driven positive engagement device comprises a plurality of driven teeth circumferentially arranged on the first side of the driven plate, and the intermediate positive engagement device comprises a plurality of intermediate teeth circumferentially arranged on the second side of the intermediate plate. In this implementation, the number of intermediate teeth is greater than a number of driven teeth.

In some implementations, the driven teeth extend axially from and radially along the first side of the driven plate and the intermediate teeth extend axially from and radially along the second side of the intermediate plate.

In some implementations, the precession angle and the number of intermediate teeth and/or the number of driven teeth are selectable to control the angular speed of the driven plate relative to the angular speed of the drive plate about the rotational axis of the driven plate.

In some implementations, the precession angle is selectable such that the angular speed of the driven plate about the axis of rotation of the driven plate varies with respect to the angular speed of the drive plate about the axis of rotation of the driven plate.

In some implementations, the first side of the drive plate is fixedly coupled to an end of an input shaft. In some implementations, the second side of the driven plate is fixedly coupled to an end of an output shaft.

In some implementations, the drive plate comprises two or more rollers that engage the first side of the intermediate plate.

In some implementations, the vertical wall of the housing is a cylindrical inner sidewall of the housing. In some implementations, the vertical wall can define at least one elongated slot, and the at least one angular stop can extend radially outwardly from the perimeter of the intermediate plate and engage the elongated slot of the vertical wall. In other implementations, the vertical wall has at least one protrusion that extends radially inwardly from the vertical wall, and wherein the at least one angular stop comprises a recess defined by the perimeter of the intermediate plate, wherein the protrusion engages the recess.

In some implementations, the at least one angular stop couples the intermediate plate and the housing via a tripod joint, a Rzeppa joint, a Tracta joint, a double cardan joint, a Weiss joint, a Thompson joint, or a Malpezzi joint.

In some implementations, the housing is rotatable about the axis of rotation of the housing separately from the drive plate, causing the intermediate plate to rotate about the axis of rotation of the driven plate, such that the angular speed of the driven plate about the axis of rotation of the driven plate is variable with respect to the angular speed of the drive plate about the axis of rotation of the driven plate.

In some implementations, the driven plate, the drive plate, and/or the intermediate plate are mass balanced and/or inertia balanced.

Various implementations are described in relation to the accompanying drawings. Other features, objects, and advantages of the various implementations are apparent from the description, drawings, and the claims.

### BRIEF DESCRIPTION OF DRAWINGS

Example features and implementations are disclosed in the accompanying drawings. However, the present disclosure is not limited to the precise arrangements and instrumentalities shown.

FIG. 1 is a perspective view of an assembled transmission device in accordance with one implementation.

FIG. 2 is an exploded view of the transmission device of FIG. 1 where the components are exploded along an axis of rotation of the driven plate.

FIG. 3 is another perspective view of the transmission device of FIG. 1 with the housing outlined to allow internal components to be visible.

FIG. 4 is a cross sectional view of the transmission device of FIG. 1 in a plane defined by the point of contact between the intermediate plate and the driven plate and the axis of rotation of the driven plate.

FIG. 5 is a perspective view of a transmission device according to another implementation.

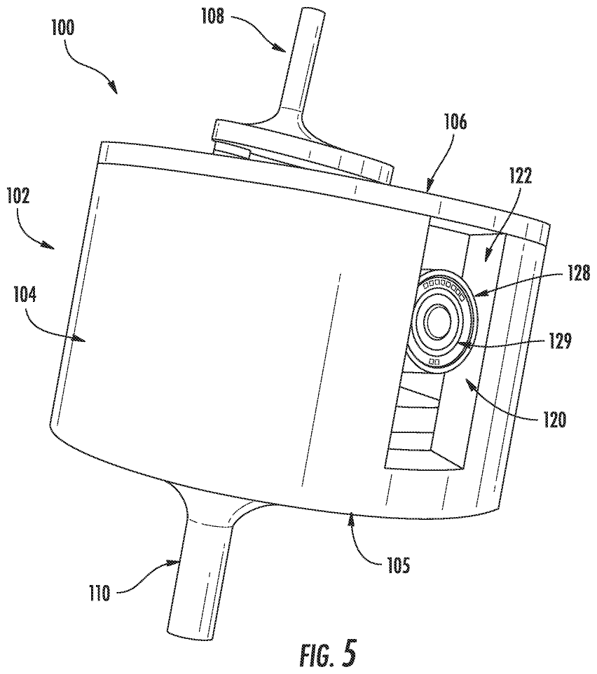

FIG. 6 is a graph of the transmission ratio as a function of the precession angle for the transmission device of FIG. 1.

FIG. 7 is a cross sectional view of a transmission device in accordance with another implementation.

### DETAILED DESCRIPTION

The following is a description of various implementations of transmission devices utilizing nutating intermediate plates.

Certain terminology is used herein for convenience only and is not to be taken as a limitation on the present invention. In the drawings, the same reference numbers are employed for designating the same elements throughout the several figures. A number of examples are provided, nevertheless, it will be understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Various implementations include transmission devices that are able to achieve high transmission ratios in a single, compact stage while maintaining high efficiency. Various implementations also leverage simple components that can be easily manufactured using standard machining practices.

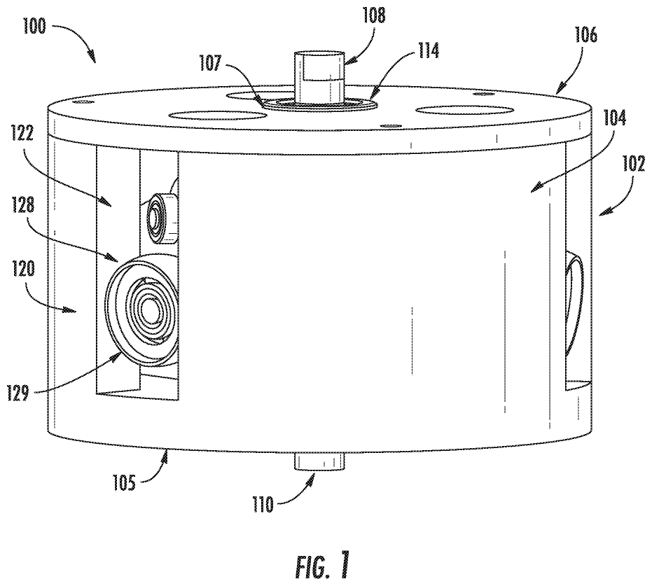

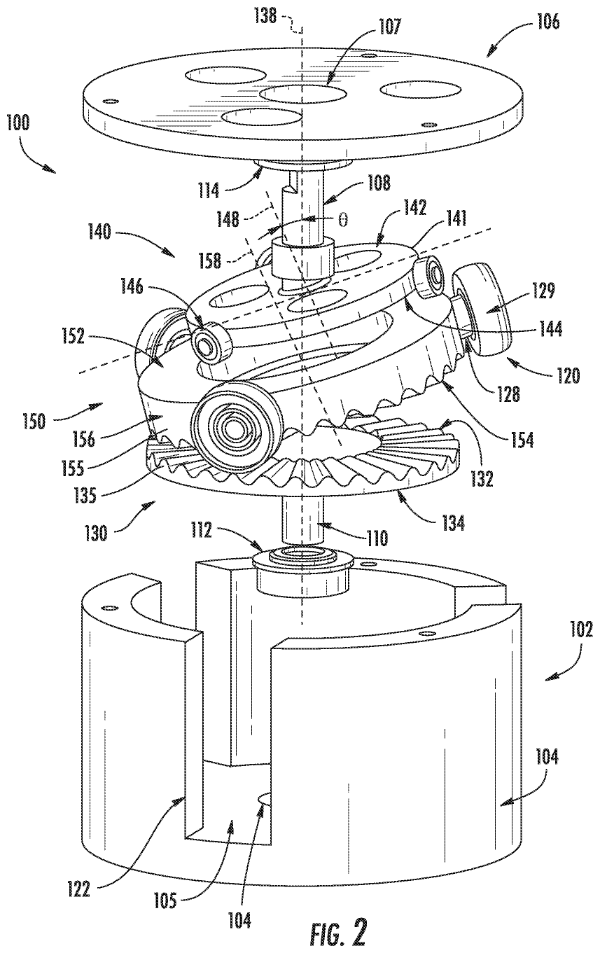

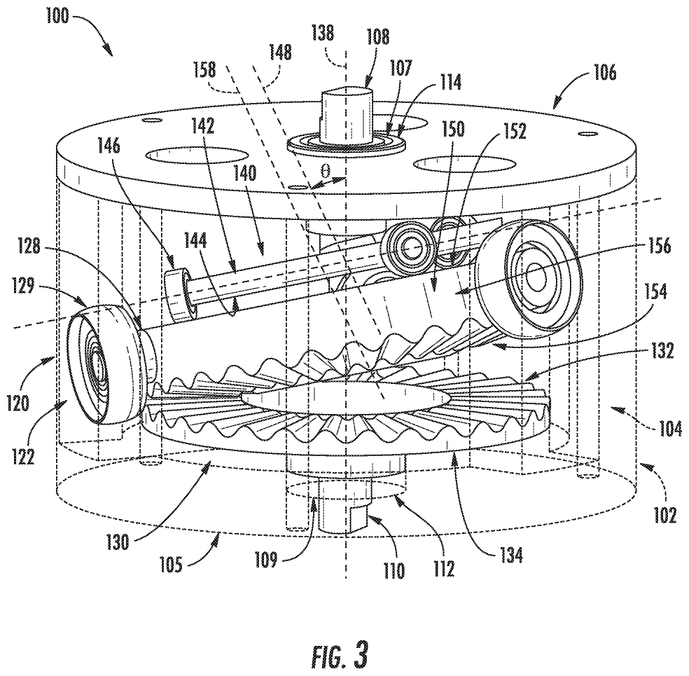

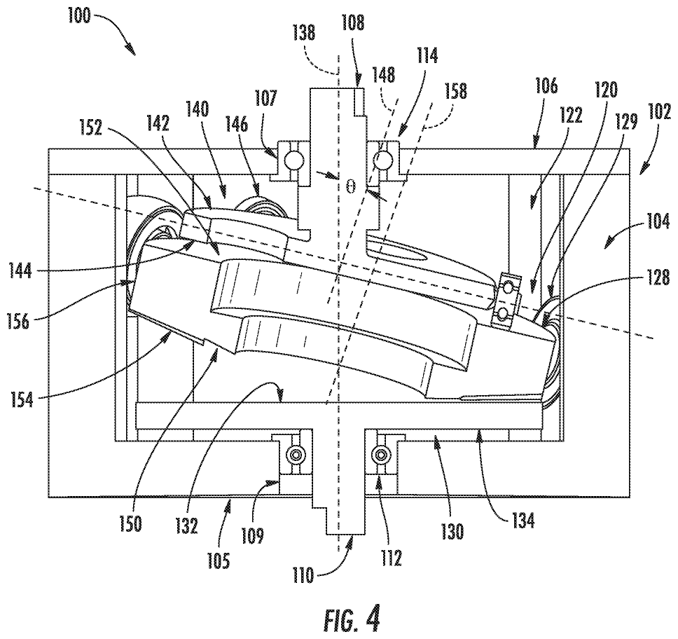

FIGS. 1-4 show one implementation of the transmission device 100 comprising a housing 102, a driven plate 130, a drive plate 140, an intermediate plate 150, and an angular stop 120.

The housing 102 comprises an axis of rotation 103, a vertical wall 104, an end wall 105, and an end cap 106. The vertical wall 104 extends circumferentially around the axis of rotation 103 of the housing 102. The end wall 105 is disposed adjacent to a first end of the vertical wall 104 and defines an end wall opening 109. The end wall opening 109 has a center through which the axis of rotation 103 of the housing 102 extends. An output bearing 112 is disposed within the end wall opening 109. The end cap 106 is disposed adjacent to a second end of the vertical wall, which is opposite the first end of the vertical wall 104 along the axis of rotation 103. The end cap 106 defines an end cap opening 107 that has a center through which the axis of rotation 103 of the housing 102 extends. An input bearing 114 is disposed within the end cap opening 107.

The driven plate 130 comprises an axis of rotation 138, a first side 132, and a second side 134. The driven plate 130 is generally disk shaped with the first side 132 and the second side 134 of the driven plate 130 spaced apart and opposite each other along the axis of rotation 138 of the driven plate 130. An output shaft 110 extends axially from the second side 134 of the driven plate 130 along the axis of rotation 138 of the driven plate 130.

The drive plate 140 comprises an axis of rotation 148, a first side 142, a second side 144, and a perimeter edge 141 that extends between the first side 142 and the second side 144. The drive plate 140 is generally disk shaped with the first side 142 and the second side 144 of the drive plate 140 spaced apart and opposite each other along the axis of rotation 148 of the drive plate 140. An input shaft 108 extends from the first side 142 of the drive plate 140. The input shaft 108 has an axis of rotation that is disposed at a precession angle θ relative to the axis of rotation 148 of the drive plate 140 that is greater than zero degrees.

The drive plate 140 further comprises a set of wheels 146 that are spaced circumferentially around a perimeter edge 141 of the drive plate 140. The wheels 146 rotate about an axis of rotation that is transverse (e.g., orthogonal) to and extends radially from the perimeter edge 141 of the drive plate 140. The wheels 146 lessen the friction between the drive plate 140 and the intermediate plate 150. However, in other implementations, other friction reducing mechanisms, such as roller mechanisms (e.g., ball bearings) or a coating, may be used to lessen the friction between the drive plate 140 and the intermediate plate 150.

The intermediate plate 150 comprises an axis of rotation 158, a first side 152, a second side 154, and a perimeter edge 156. The intermediate plate 150 is generally disk shaped with the first side 152 and the second side 154 of the intermediate plate 150 spaced apart and opposite each other along the axis of rotation 158 of the intermediate plate 150. The perimeter edge 156 of the intermediate plate 150 extends between the first side 152 and the second side 154 of the intermediate plate 150.

The angular stop 120 comprises elongated slots 122, radial extensions 128, and angular stop rollers 129. The elongated slots 122 are defined by the vertical wall 104 of the housing 102 and extend linearly parallel to the axis of rotation 103 of the housing 102. The radial extensions 128 are disposed circumferentially along the perimeter edge 156 of the intermediate plate 150 and extend radially outwardly from the perimeter edge 156 of the intermediate plate 150. The angular stop rollers 129 are coupled to the radially outermost ends of the radial extensions 128. The rollers 129 rotate about axes that extend radially outwardly from and transverse (e.g., orthogonal) to the radially outermost ends of the radial extensions 128. The angular stop 120 of FIGS. 1-4 has three elongated slots 122, radial extensions 128, and angular stop rollers 129, but other implementations may have any number of elongated slots, radial extensions, and angular stop rollers. While the angular stop 120 of FIGS. 1-4 comprises angular rollers 129 in the form of wheels, the angular rollers of other implementations may comprise other types of angular stop rollers (e.g., ball bearings) to lessen the friction between the one or more elongated slots and the one or more radial extensions. And, in some implementations, the angular stop may not include angular stop rollers, and the radial extensions engage the slots. In other implementations, radial protrusions may extend from the vertical wall of the housing, and the perimeter edge of the intermediate plate may define recesses for receiving the protrusions.

When assembled, the driven plate 130 is disposed within the housing 102 with the second side 134 of the driven plate 130 adjacent the end wall 104. The output shaft 110 is disposed within, and protrudes through, the output bearing 112 such that the end of the output shaft 110 furthest from the driven plate 130 is outside the housing 102. And, the axis of rotation 138 of the driven plate 130 is coincident with the axis of rotation 103 of the housing 102. The drive plate 140 is also disposed within the housing 102 with the first side 142 of the drive plate 140 adjacent the end cap 106. The input shaft 108 is disposed within, and protrudes through, the input bearing 114 such that the end of the input shaft 108 furthest from the drive plate 140 is outside the housing 102. The axis of rotation of the input shaft 108 is coincident with the axis of rotation 138 of the driven plate 130. The intermediate plate 150 is disposed within the housing 102 between the driven plate 130 and the drive plate 140 such that the drive plate 140 engages (e.g., directly or indirectly, such as via wheels, a rolling mechanism, or other friction reducing mechanism) the first side 152 of the intermediate plate 150, and a portion 155 of the second side 154 of the intermediate plate 150 engages a portion 135 of the first side 132 of the driven plate 130. The angular stop rollers 129 are disposed within the elongated slots 122.

Because the second side 144 of the drive plate 140 engages the first side 152 of the intermediate plate 150 and because the axis of rotation 148 of the drive plate 140 intersects the axis of rotation 138 of the driven plate 130 at the precession angle θ, the orientation of the drive plate 140 urges the axis of rotation 158 of the intermediate plate 150 to be parallel to the axis of rotation 148 of the drive plate 140. Thus, the axis of rotation 158 of the intermediate plate 150 intersects the axis of rotation 138 of the driven plate 130 at the precession angle θ as well. As the input shaft 108 rotates about the axis of rotation 138 of the driven plate 130, the axis of rotation 148 of the drive plate 140 rotates about the axis of rotation 138 of the driven plate 130 at the precession angle. The rotation of the axis of rotation 148 of the drive plate 140 about the axis of rotation 138 of the driven plate 130 causes the axis of rotation 158 of the intermediate plate 150 to rotate about the axis of rotation 138 of the driven plate 130. However, the intermediate plate 150 is prevented from rotating about its axis of rotation 158 by the angular stop 120. Accordingly, the angular stop rollers 129 traverse the elongated slots 122 as the rotation of the drive plate 140 causes the portion 155 of the intermediate plate 150 that engages the portion 135 of the first surface 132 of the driven plate 130 to change circumferentially. The engagement of the portion 155 of the intermediate plate 150 with the portion 135 of the first surface 132 of the driven plate 130 causes rotation of the driven plate 130 about its rotational axis 138, which rotates the output shaft 110.

The transmission device 100 is based on the kinematics of a plate spinning and rolling on a flat surface, such as is encountered when spinning a coin on a table. The “wobbling” effect of the non-rotating intermediate plate 150 as its axis of rotation 158 rotates about the axis of rotation 138 of the driven plate 130 at the precession angle is called nutation. Thus, the drive plate 140 serves as a three-dimensional cam to cause the portion 155 of the intermediate plate 150 that engages the portion 135 of the driven plate 130 to change circumferentially. The intermediate plate 150 has a fixed radius, and therefore a fixed circumference. However, the path traversed by the portion 155 of the intermediate plate 150 along the first side 132 of the driven plate 130 is smaller than the circumference of the intermediate plate 150 due to the precession angle between the axis of rotation 158 of the intermediate plate 150 and the axis of rotation 138 of the driven plate 130. This difference in the circumferences cause the portion 155 of the intermediate plate 150 to simultaneously roll, or move circumferentially, along the first side 132 of the driven plate 130. The ratio of the rolling rate to the rotation rate depends on the precession angle θ between the intermediate plate 150 and the first side 132 of the driven plate 130 upon which it is rolling. The rolling contact of the portion 155 of the intermediate plate 150 with the driven plate 130 causes the driven plate 130 and output shaft 110 to rotate about the axis of rotation 138 of the driven plate 130 at an angular speed that is less than the angular speed of the input shaft 108.

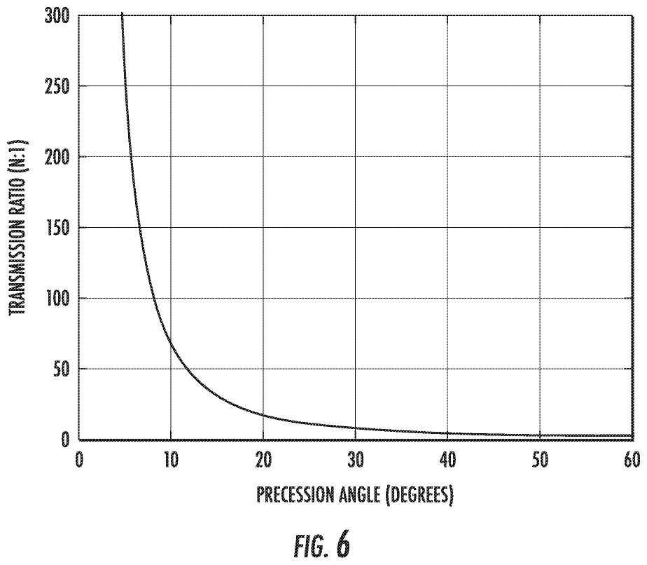

By driving the rotation of the input shaft 108 at a specific angular speed using a driving unit such as a motor and controlling the precession angle θ, a desired angular speed of the output shaft 110 can be achieved. The ratio of the angular speeds of the input shaft 108 and output shaft 110 is referred to as the transmission ratio. By designing a transmission device based on this precession angle θ, very high transmission ratios (e.g., 250:1 or 300:1) can be achieved in a single stage without the use of large components. Theoretically, the transmission ratio approaches infinity as the precession angle approaches zero degrees. The following equation shows the relationship of the precession angle, θ, to the transmission ratio, N. The equation is also plotted in FIG. 6.

$$N = \frac{1}{1 - cos ( θ )} \qquad ( 1 )$$

In some implementations, the transmission device is a continuously variable transmission (CVT) device, and the transmission ratio is varied by varying the precession angle θ of the intermediate plate 150. As the precession angle θ decreases relative to the axis of rotation 138 of the driven plate 130, the transmission ratio increases. The precession angle θ of the intermediate plate 150 can be varied by varying the precession angle θ of the drive plate 140 as it engages the first side 152 of the intermediate plate 150.

In addition, positive engagement features, such as teeth, extend axially from the second surface 154 of the intermediate plate 150 and the first surface 132 of the driven plate 130 and engage with each other. In this implementation, transmission occurs without the use of a traction or friction-based drive mechanism, which are typically provided in CVT devices. The positive engagement features, such as teeth, may be provided between the intermediate plate 150 and driven plate 130 to prevent slipping between these two components. In the implementation of FIGS. 1-4, driven teeth are arranged to extend axially from the first side 132 of the driven plate 130 and intermediate teeth arranged to extend axially from the second side 154 of the intermediate plate 150. The driven teeth extend radially along and circumferentially around the first side 132 of the driven plate 130, and the intermediate teeth extend radially along and circumferentially around the second side 154 of the intermediate plate. The intermediate teeth and driven teeth are engagable. In some implementations, the number of intermediate teeth is greater than the number of driven teeth. In these implementations, the number of intermediate teeth and/or the number of driven teeth can be selected to correspond to a selected precession angle θ to control the angular speed of the driven plate 130 relative to the angular speed of the drive plate 140 about the rotational axis 138 of the driven plate 138. In other words, the number of teeth for each plate can be selected with the precession angle θ to vary the transmission ratio of the transmission device.

While FIGS. 1-4 depict the intermediate plate 150 and driven plate 130 comprising positive engagement features such as teeth to prevent slipping between these components, some implementations do not use positive engagement features. For example, in some implementations, friction between the intermediate plate 150 and the driven plate 130 transfers rotation from the intermediate plate 150 to the driven plate 130.

In other implementations, such as in some non-steady-state actuation applications, it may be desirable to modulate the transmission ratio of the transmission device 100 by other means. For example, as an alternative or in addition to changing the precession angle of the drive plate 130, the transmission ratio may be varied by changing the angular velocity of the angular stop 120 about and relative to the axis of rotation 138 of the driven plate 130 using a separate input, such as a motor or gears, to rotate the housing 103 separately from the input shaft 108, drive plate 140, output shaft 110, and the driven plate 130. For example, the vertical wall 104 of the housing 102 may be mounted on bearings or include other friction reducing mechanisms to reduce friction during the rotation of the vertical wall 104 of the housing 102 by the separate input. In some implementations, the angular stop 120 is defined in part by a second vertical wall (separate from the vertical wall of the housing) that is disposed within the housing around the drive plate, intermediate plate and driven plate. As described above, the angular velocity of the angular stop 120 can be varied about and relative to the axis of rotation 138 of the driven plate 130 to rotate the housing 103 separately from the input shaft 108, drive plate 140, output shaft 110, and the driven plate 130 by rotating the second vertical wall independently of the plates, and the housing may remain stationary. The second vertical wall may be mounted on bearings or other friction reducing mechanisms.

In FIGS. 1-4, the angular stop is at least one elongated slot defined in the vertical wall of the housing and a radial extension from the intermediate plate that engages the at least one elongated slot. However, as noted above, in other implementations, the angular stop includes at least one protrusion extending radially inwardly from the vertical wall of the housing that engages at least one recess defined by the outer rim of the intermediate plate.

FIGS. 1-4 depict an implementation in which the angular stop 120 forms a tripod joint between the intermediate plate 150 and the housing 102. However, many different implementations of the angular stop are possible in which the vertical wall of the housing and the intermediate plate are prevented from relative rotation about the axis of rotation of the driven plate. In other implementations, the angular stop comprises at least one guide channel defined by each of the vertical wall of the housing and the perimeter edge of the intermediate plate. The guide channel defined by the vertical wall extends radially into the vertical wall, and the guide channel defined by the perimeter edge extends radially into the perimeter edge, and the guide channels radially oppose each other. A coupling element is disposed between the radially opposed guide channels. For example, a rolling or sliding element, such as a ball bearing, may engage the guide channels to constrain the relative motion of the intermediate plate and the housing. Such an implementation may be used in a Rzeppa joint or other similar mechanism. And, in other implementations, the angular stop forms a Tracta joint, a double cardan joint, a Weiss joint, a Thompson joint, or a Malpezzi joint. Other types of joint configurations may also be used to form the angular stop 120.

The implementation of the transmission device depicted in FIGS. 1-4 has a single-supported input shaft 108 and a single supported output shaft 110. However, the input 108 or output shaft 110 may be double supported with multiple bearings 112, 114 to reduce stresses within these components.

It may also be desirable to balance the drive plate 140, intermediate plate 150, and/or the driven plate 130 to prevent vibrations or high loads on bearings or the housing 102. In some implementations, these plates are mass balanced. In some implementations, the drive plate 140, the intermediate plate 150, and/or the driven plate 130 are inertia balanced.

The transmission device 100 employs elements that contact each other via rolling such that sliding friction or deformable elements common in other transmission designs may be eliminated from the design. Because of the rolling friction between components as opposed to sliding friction, the transmission device 100 can achieve high efficiencies. Additionally, the components can be simple in their construction, thereby allowing low manufacturing costs relative to other high ratio single-stage transmissions, where complicated and precise components drive up manufacturing costs.

Previous designs of nutation-based transmission systems have prevented the rotation of an intermediate plate relative to the housing by using a reaction control member (RCM) on the driving-end end cap of the housing. Many of these designs employ face gear teeth on the end cap that engage face gear teeth on the intermediate plate to prevent rotation. However, this approach leads to the need for very precisely machined intermediate plates with costly gear teeth machined on both faces of the plates. By providing the angular stop 120 between the vertical wall 104 of the housing 102 and the intermediate plate in the transmission devices described herein, two precision-machined surfaces (the top face of an intermediate plate and a face of the end cap) can be eliminated, thereby allowing for a possible reduction in machining costs. Additionally, the pure rolling that is possible with the angular stop rollers 129 of the angular stop 120 of FIGS. 1-4 can allow for a higher efficiency device than those devices utilizing teeth that mesh due to the friction inherent to the multiple meshing faces. Also, the angular stop 120 in the above described implementations allows the transmission device 100 to achieve a more compact form by the elimination of the gear teeth machined onto the end cap in the prior art.

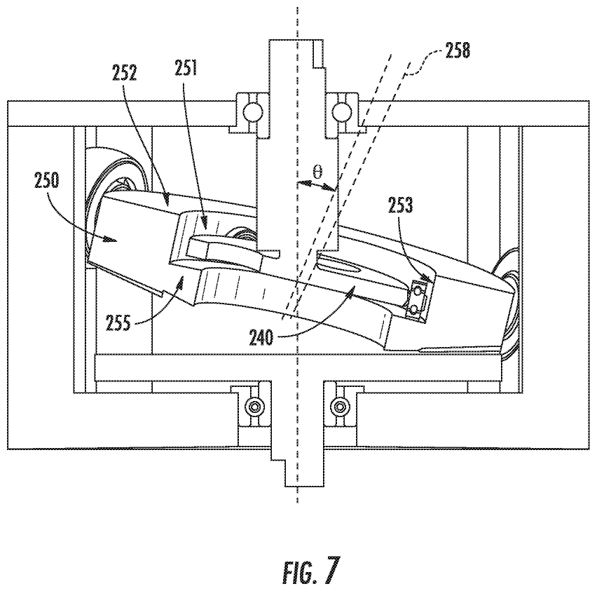

The implementation of the transmission device pictured in FIGS. 1-3 has an intermediate plate 150 that is disposed between the drive plate 140 and driven plate 130 such that the orientation of the drive plate 140 relative to the axis of rotation of the driven plate 138, along with the angular stop 120 and driven plate 130, locates the position and orientation of the intermediate plate 150. In this implementation, the second side 144 of the drive plate 140 is disposed in a plane that is coplanar with or spaced axially apart from a plane that includes the first side 152 of the intermediate plate 150 in a direction away from the driven plate 130. However, in some alternative implementations, such as shown in FIG. 7, the first side 252 of the intermediate plate 250 defines a recess 251 that extends along the axis of rotation 258 of the intermediate plate 250, and the drive plate 240 is rotatably disposed at least partially within the recess 251 such that a portion of the drive plate 240 engages a portion of the walls of the intermediate plate 250 that define the recess 251. For example, in some implementations, the recess 251 in the intermediate plate 250 comprises an annular lip 255 (or solid surface) protruding radially inwardly from an inside wall 253 of the recess 251 toward the axis of rotation 258 of the intermediate plate 250. The drive plate 240 engages at least a portion of the lip 255 and/or the inside wall 253 of the recess 251 in the intermediate plate 250. And, in other implementations (not shown), the recess in the intermediate plate comprises a first lip and a second lip, wherein both lips protrude radially inwardly from the inside wall of the recess and are axially spaced apart from each other. The drive plate engages a portion of one or both of the lips and/or the inside wall of the recess in the intermediate plate. Such configurations allow for a more compact transmission device.

A number of implementations of the invention have been described. Nevertheless, it will be understood that various modifications may be made without departing from the spirit and scope of the invention. Accordingly, other implementations are within the scope of the following claims.

Disclosed are materials, systems, devices, compositions, and components that can be used for, can be used in conjunction with, can be used in preparation for, or are products of the disclosed methods, systems and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

1. A speed reduction device comprising:
a housing having an axis of rotation, the housing having a vertical wall;
a driven plate having an axis of rotation, wherein the axis of rotation of the driven plate is coincident with the axis of rotation of the housing, the driven plate having a first side and a second side spaced apart and opposite each other along the axis of rotation of the driven plate, wherein the driven plate is disposed within the housing;
a drive plate having an axis of rotation, wherein the axis of rotation of the drive plate intersects the axis of rotation of the driven plate at a precession angle greater than zero, the drive plate having a first side and a second side spaced apart and opposite each other along the axis of rotation of the drive plate, wherein the drive plate is disposed within the housing;
an intermediate plate having an axis of rotation, wherein the axis of rotation of the intermediate plate intersects the axis of rotation of the driven plate at the precession angle, the intermediate plate having a first side, a second side, and a perimeter edge extending between the first side and the second side, the first and second sides being spaced apart along the axis of rotation of the intermediate plate, wherein the intermediate plate is disposed within the housing between the drive plate and the driven plate; and
at least one angular stop coupling the intermediate plate and the housing, the at least one angular stop preventing the intermediate plate from rotating relative to the housing and allowing the axis of rotation of the intermediate plate to precess about the axis of rotation of the driven plate,
wherein rotation of the drive plate about the axis of rotation of the driven plate at an angular speed urges the intermediate plate to nutate about the axis of rotation of the driven plate, and the nutation of the intermediate plate causes the driven plate to rotate about the axis of rotation of the driven plate at an angular speed that is less than the angular speed of the drive plate.

2. The speed reduction device of claim 1, wherein:
the driven plate comprises a driven positive engagement device on the first side of the driven plate,
the intermediate plate comprises an intermediate positive engagement device on the second side of the intermediate plate, and
the intermediate positive engagement device is engagable with the driven positive engagement device.

3. The speed reduction device of claim 2, wherein:
the driven positive engagement device comprises a plurality of driven teeth circumferentially arranged on the first side of the driven plate, and
the intermediate positive engagement device comprises a plurality of intermediate teeth circumferentially arranged on the second side of the intermediate plate, wherein a number of intermediate teeth is greater than a number of driven teeth.

4. The speed reduction device of claim 3, wherein the driven teeth extend axially from and radially along the first side of the driven plate and the intermediate teeth extend axially from and radially along the second side of the intermediate plate.

5. The speed reduction device of claim 4, wherein the precession angle and the number of intermediate teeth and/or the number of driven teeth are selectable to control the angular speed of the driven plate relative to the angular speed of the drive plate about the rotational axis of the driven plate.

6. The speed reduction device of claim 1, wherein the precession angle is selectable such that the angular speed of the driven plate about the axis of rotation of the driven plate varies with respect to the angular speed of the drive plate about the axis of rotation of the driven plate.

7. The speed reduction device of claim 1, wherein the first side of the drive plate is fixedly coupled to an end of an input shaft.

8. The speed reduction device of claim 1, wherein the second side of the driven plate is fixedly coupled to an end of an output shaft.

9. The speed reduction device of claim 1, wherein the drive plate comprises two or more rollers that engage the first side of the intermediate plate.

10. The speed reduction device of claim 1, wherein the vertical wall is a cylindrical inner sidewall of the housing.

11. The speed reduction device of claim 1, wherein the angular stop comprises at least one elongated slot defined by the vertical wall and at least one radial extension extending radially outwardly from the perimeter edge of the intermediate plate, wherein the radial extension engages the elongated slot.

12. The speed reduction device of claim 1, wherein the angular stop comprises at least one protrusion that extends radially inwardly from the vertical wall and at least one recess defined by the perimeter edge of the intermediate plate, wherein the protrusion engages the recess.

13. The speed reduction device of claim 1, wherein the at least one angular stop couples the intermediate plate and the housing via a tripod joint.

14. The speed reduction device of claim 1, wherein the at least one angular stop couples the intermediate plate and the housing via a Rzeppa joint.

15. The speed reduction device of claim 1, wherein the at least one angular stop couples the intermediate plate and the housing via a Tracta joint.

16. The speed reduction device of claim 1, wherein the at least one angular stop couples the intermediate plate and the housing via a double cardan joint.

17. The speed reduction device of claim 1, wherein the at least one angular stop couples the intermediate plate and the housing via a Weiss joint.

18. The speed reduction device of claim 1, wherein the at least one angular stop couples the intermediate plate and the housing via a Thompson joint.

19. The speed reduction device of claim 1, wherein the at least one angular stop couples the intermediate plate and the housing via a Malpezzi joint.

20. The speed reduction device of claim 1, wherein the housing is rotatable about the axis of rotation of the housing separately from the drive plate, causing the intermediate plate to rotate about the axis of rotation of the driven plate, such that the angular speed of the driven plate about the axis of rotation of the driven plate is variable with respect to the angular speed of the drive plate about the axis of rotation of the driven plate.

21. The speed reduction device of claim 1, wherein the driven plate, the drive plate, and/or the intermediate plate are mass balanced.

22. The speed reduction device of claim 1, wherein the driven plate, the drive plate, and/or the intermediate plate are inertia balanced.
